(19) United States
(12) Patent Application Publication
(10) Pub. No.: US 2011/0153378 A1
(43) Pub. Date: Jun. 23, 2011

(54) Methods and Systems for Managing Customer Contacts in a Contact Center

(75) Inventors: John Costello, Galway (IE); Neil O'Connor, Galway (IE); John Yoakum, Cary, NC (US)

(73) Assignee: NORTEL NETWORKS LIMITED, St. Laurent (CA)

(21) Appl. No.: 12/641,580

(22) Filed: Dec. 18, 2009

(51) Int. Cl. G06Q 10/00; G06F 15/173

(52) U.S. Cl. 705/7.12; 709/226; 705/7.13

(57) ABSTRACT

A computer-implemented method of reserving resources for a customer contacting a contact center. The method includes the steps of identifying the customer associated with a contact received at the contact center, accessing a customer profile to determine at least one non-agent resource to be associated with the contact based on the customer profile; reserving the non-agent resource for the contact; and allocating the non-agent resource to the contact.

### FIELD OF THE INVENTION

The present invention relates to a methods and systems for managing customer contacts in a contact center.

### BACKGROUND ART

Contact centers are widely used to allow an enterprise or business to efficiently handle customer enquiries, complaints and support, and to allow an enterprise to make contact with existing or potential customers.

A widely recognised difficulty exists when contact centers cannot efficiently handle calls at any given time. (The term “calls” here is not intended to denote solely voice telephony calls as many contact centers provide multimedia communication between agents of the center and customers or remote users, so that “calls” is intended to encompass voice and video calls, internet chat sessions, emails, short messaging service (SMS) messages and any other such communications between a remote user and an agent. Similarly, while the term “call center” will be used interchangeably with “contact center”, it is to be understood that this is not a limitation on the type of contact center to which the invention applies.)

Traditionally, customers have interacted with contact centers by initiating contact with the intention (usually) of speaking with an agent. A typical contact center will have two main components, namely a network interface such as a switch or a private branch exchange (PBX) which handles the calls themselves, and a management component such as a contact center server for controlling the operation of the PBX to direct calls to suitable agents.

Thus, based on information gleaned from the call in its initial stages (e.g. from menu choices made in an interactive voice response (IVR) session), the contact center server will determine a skillset, which an agent would ideally require to handle the call. A suitable agent is identified from those currently active at the center, taking into account the number of calls currently on hold for that agent and other relevant data available to the contact center server, and the PBX is directed to transfer the call to the directory number (DN) or the position ID of that agent by the contact center server when the agent becomes free.

The gleaning of information in order to appropriately associate a call with a preference for a skillset of a particular agent assists in the efficient management of the calls, in that once the customer is put in contact with the agent, the agent is equipped with the necessary skillset to address the customer's needs.

Nonetheless, the present invention is addressed at improving the management of customer contacts to thereby provide a more efficient call center service.

### SUMMARY OF THE INVENTION

According to an aspect of the present invention there is provided a computer-implemented method of reserving resources for a customer contacting a contact center, the method including the steps of:
a) identifying said customer associated with a contact received at said contact center;
b) accessing a customer profile to determine at least one non-agent resource to be associated with said contact based on said customer profile;
c) reserving said non-agent resource for said contact; and
d) allocating said non-agent resource to said contact.

Preferably, said customer profile comprises a record of at least one prior contact between said customer and a contact center.

Preferably, said customer profile comprises information gleaned from at least one of a social networking site, an online public forum, and a market research organisation.

Preferably, said identifying said customer comprises determining an order number, an open issue tracking number, or an identifier that associates the customer with a commercial or other transaction with the business, associated with said at least one prior contact.

Preferably, said identifying said customer comprises identifying a communications address from which said contact is received, the communications address being selected from a telephone number, an IP address, an email address, a SIP address, an IM address, and a uniform resource indicator.

Preferably, said identifying said customer comprises gleaning a customer identifier during an IVR session.

Preferably, after the step of reserving said non-agent resource and before the step of allocating said non-agent resource to said contact, said non-agent resource is made unavailable for reservation by or allocation to other contacts of said contact center.

Preferably, said method further comprising the step of releasing said non-agent resource after allocating said non-agent resource to said contact, such that after releasing said non-agent resource it is made available for reservation by or allocation to other contacts of said contact center.

Preferably, said step of releasing said non-agent resource is carried out by a management system of said contact center in response to an instruction received from said customer.

Preferably, said step of releasing said non-agent resource is carried out by a management system of said contact center in response to a termination of said contact.

Preferably, said method further comprising the step of assigning a human agent of said contact center to said contact to engage with said contact, whereby said agent is engaged with said contact during a first period of time which overlaps with a second period of time defined between said steps of reserving said non-agent resource and allocating said non-agent resource.

Preferably, said step of allocating the resource to the contact comprises disengaging said human agent from said contact, such that the first and second periods of time end substantially simultaneously.

Alternatively, said method further comprising the step of assigning a human agent of said contact center to said contact to engage with said contact, and wherein allocating said non-agent resource to said contact comprises maintaining a conference call between at least said customer, said non-agent resource and said human agent.

Preferably, responsive to said human agent determining at least one additional non-agent resource to be associated with said contact, reserving said additional non-agent resource.

Preferably, determining additional non-agent resources for association with said contact is based on a customer request, information gleaned from said customer, and/or a recommendation by said agent.

Preferably, said step of reserving said at least one non-agent resource comprises determining that said non-agent resource is allocated to or reserved for a second contact associated with a second customer, and adding a reserve request for said contact to a reserve queue associated with the non-agent resource.

Alternatively, said step of reserving said at least one non-agent resource comprises determining that said non-agent resource is allocated to or reserved for a second contact associated with a second customer, determining that said second customer has a lower priority level than the customer, and usurping the non-agent resource from the second contact.

Preferably, said step of reserving said at least one non-agent resource comprises determining that said non-agent resource is reserved for a second contact associated with a second customer, usurping the non-agent resource from the second contact.

Preferably, said step of reserving said at least one non-agent resource comprises determining that said non-agent resource is allocated for a second contact associated with a second customer, adding a reserve request for said contact to a reserve queue associated with the non-agent resource.

There is also provided a corresponding contact centre system comprising:
a) a network connection for receiving a contact from a customer;
b) a contact manager for identifying said customer associated with a contact received at said network connection;
c) a storage area containing a customer profile from which it is possible to determine at least one non-agent resource to be associated with said contact based on said customer profile;
d) a resource reservation system operable to reserve said non-agent resource for said contact; and
e) a resource allocation system for allocating said non-agent resource to said contact.

According to a second aspect of the present invention there is provided a computer-implemented method of reserving resources for a customer contacting a contact center, the method including the steps of:
a) identifying the customer associated with a contact received at the contact center;
b) accessing a resource set of preemptively identified potentially relevant non-agent resources that may be required by the customer;
c) reserving the non-agent resource for the contact; and
d) allocating the resource to the. contact.

There is also provided a corresponding contact centre system comprising:
a) a network connection for receiving a contact from a customer;
b) a contact manager for identifying said customer associated with a contact received at said network connection;
c) a storage area containing a resource set of preemptively identified potentially relevant non-agent resources that may be required by the customer;
d) a resource reservation system operable to reserve said non-agent resource for said contact; and
e) a resource allocation system for allocating said non-agent resource to said contact.

According to a third aspect of the present invention there is provided a computer-implemented method of reserving resources for a customer contacting a contact center, the method including the steps of:
a) accessing a customer profile;
b) identifying a resource set of potentially relevant non-agent resources that may be required by the customer, based on said customer profile;
c) responsive to receipt of a subsequent customer contact, reserving at least one of the resources of the resource set for the customer contact.

There is also provided a corresponding contact centre system comprising:
a) a storage area containing a customer profile from which it is possible to determine a resource set of potentially relevant non-agent resources that may be required by a customer based on said customer profile;
b) a resource identification system for identifying, in advance of a contact from a customer, a resource set of potentially relevant non-agent resources that may be required by a customer based on said customer profile; and
c) a resource reservation system operable, in response to receipt of a customer contact at the contact centre, to reserve at least one of the resources of the resource set for the customer contact.

Further benefits and advantages of the invention will become apparent from a consideration of the following detailed description given with reference to the accompanying drawings, which specify and show preferred embodiments of the invention.

### BRIEF DESCRIPTION OF THE DRAWINGS

In order to show how the invention may be carried into effect, embodiments of the invention are now described below by way of example only and with reference to the accompanying figures in which:

FIG. 1 is a block diagram showing the architecture of a contact center and its environment;

FIG. 2 is an exemplary customer history profile maintained in a database record of the contact center of FIG. 1;

FIG. 3 is a alternative exemplary customer history profile maintained in a database record of the contact center of FIG. 1;

FIG. 4 is a flow diagram of a method of managing a contact received at the contact center of FIG. 1;

### DETAILED DESCRIPTION OF THE INVENTION

Embodiments of the present invention are described below by way of example only. These examples represent the best ways of putting the invention into practice that are currently known to the Applicant although they are not the only ways in which this could be achieved.

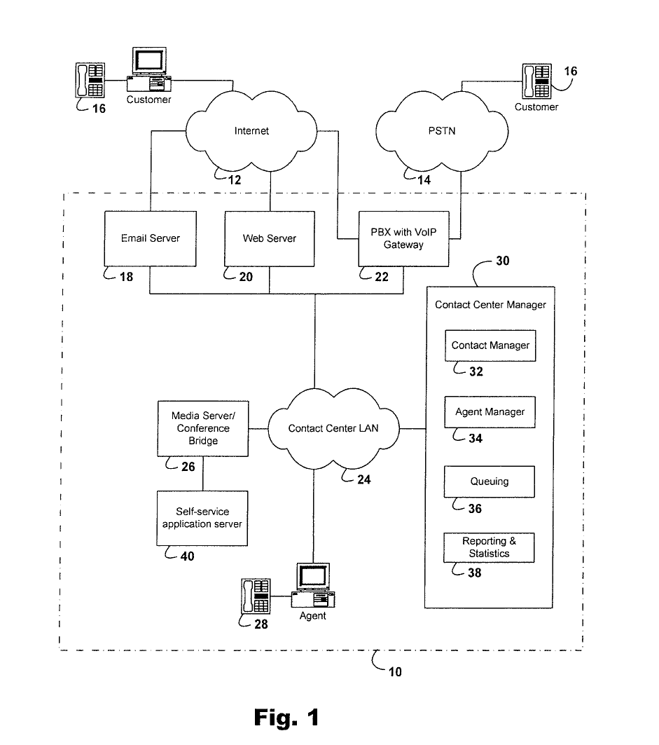

In FIG. 1 there is indicated, generally at 10, a contact center which is connected both to the Internet 12 and to the public switched telephone network (PSTN) 14. Customers 16 can connect via either the Internet or the PSTN to the contact center generally, and in particular can connect to an email server 18, a web server 20 or (most usually) a private branch exchange (PBX) 22 equipped with a voice over Internet protocol (VOIP) gateway and/or a video interface.

The contact center 10 has a local area network (LAN) 24, which connects each of the servers 18, 20, 22 with a media server/conference bridge 26. A plurality of agents 28 (one of whom is indicated in FIG. 1) are also connected using an agent workstation which is a personal computer equipped with agent client software providing multimedia capabilities to the contact center LAN.

It is to be understood that agents may be connected also to the contact center via the Internet 12 or via a wide area network, and they can also be connected over the PSTN. Such distributed contact center architectures are well known and the present invention is not limited to any particular architecture of contact center.

Customers contact the contact center by, for example, making a voice or video call over the Internet or the PSTN, which is handled by the PBX 22. Customers can also make contact by a chat session hosted on the web server 20.

(In addition to such “live” contact sessions, with which the present invention is primarily concerned, it can be seen that the contact center can also receive submissions from web forms hosted on the web server 20, or from a customer email which is received at the email server 18.)

In any event, when a live contact such as a voice or video call or a chat session request is received at the respective server, a contact center manager 30 is notified of the existence of a new contact. The contact center manager 30 performs a number of functions some of which are indicated generically such as a contact manager 32, an agent manager 34, a queuing function 36 and a reporting and statistics function 38. As the skilled person will appreciate, each of these functions is typically implemented by appropriate software elements forming part of an overall contact center management application. This does not exclude the possibility that a contact center manager can be implemented purely in hardware or as a hybrid.

The contact manager 32 generates a new contact entity which records details of the received contact such as the time it was received, its source, any customer details which can be deduced based on the source (e.g. the caller line ID or an IP address might be used to reference a customer profile in a database), and the nature of the contact (e.g. customers may have access to a first communication channel for sales or a second communication channel for technical support, etc.).

In order to increase the sophistication of the contact handling, the customer is typically directed first through an automated system to acquire more information, which will allow the contact to be better directed. Again, the skilled person will be familiar with the techniques, which can be used and therefore only a brief description of a typical method of contact handling will be given.

The most common contact type in current contact centers is voice calls, and as indicated above, such calls are initially handled by the PBX. The contact manager 32, following the generation of a contact, instructs the PBX 22 to transfer the call to the media server/conference bridge 26. This bridge effectively generates an ad hoc conference into which the customer's call is placed.

A self-service application server 40 is connected into the same conference and a script is run on the server 40 which plays back various recorded announcements and accepts inputs from the customer in response to such announcements in order to either dispose of the contact (if automated handling can satisfy all of the needs of that particular customer) or to determine the skillset(s) required for an agent to handle the customer. In addition to simple recorded announcement playback, more sophisticated self service applications are increasingly deployed which can interact with the customer and respond to limited customer requests, such as by speaking a customer's bank balance.

In normal operation, the script will allow the customer to navigate through the application either to a point where it has been determined that the customer query is satisfied (such as when the customer has heard the account balance) or to a point where it has been determined that the customer should be connected to a human agent. Often the latter option is available at any point in the menu structure by pressing a specified key.

When the script has terminated, the information gleaned from this session is passed back to the contact manager to update the contact and to more appropriately queue the contact (unless the contact has terminated following either a successful or an unsuccessful navigation of the menu structure provided by the script). When a contact is queued, i.e. unless an agent is available immediately to deal with the contact, the customer will typically be provided with a media feed.

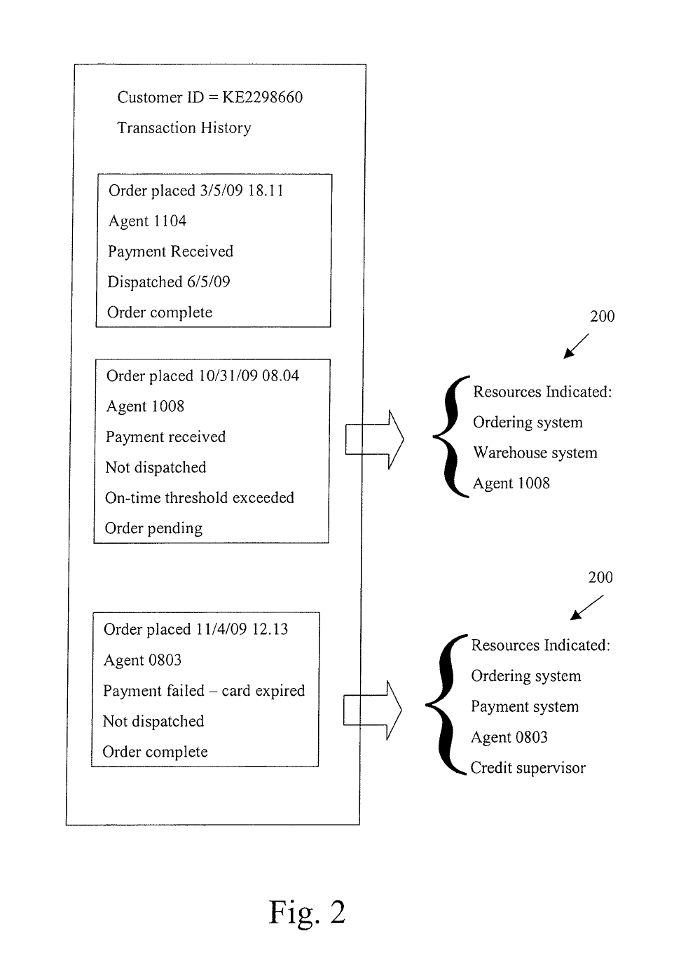

An example of a plurality of contact entities maintained for a given customer is displayed in FIG. 2. In particular, there is illustrated, a transaction history of a customer having customer ID KE2298660 and comprises three entries detailing contacts the customer made with the contact center.

The first contact entry relates to an order that was placed on Mar. 5, 2009 at 18.11. The order was dealt with by agent 1104, and payment was received. The order was dispatched and is indicated as having been completed.

The second contact entry relates to an order that was placed on Oct. 31, 2009 at 08.04. The order was dealt with by agent 1008, and payment was received. The order was not dispatched, and is indicated as exceeded an acceptable time limit threshold for dispatch. Accordingly, the order is indicated as pending.

The third contact entry relates to an order that was placed on Nov. 4, 2009 at 12.13. The order was dealt with by agent 0803, but payment was not received. Thus, the order was not dispatched and is indicated as currently pending.

The contact manager 32 and/or the self-service sensor 40 is arranged to utilise the information maintained in the transaction history of each customer to preemptively identify resources that may be required by the customer should they contact the contact center.

Such resources may comprise agents, and non-agents, such as, supervisors, specialists, experts, systems, hardware, for example, ports, and software, for example, web service applications etc.

To this end, the contact manager 32 generates a set of resources 200 comprising those resources deemed relevant to the customer, or in a more particular case, to each contact of the transaction history of the customer.

In the case exemplified in FIG. 2, the contact manager 32 determines that the first contact of the transaction history for customer ID KE2298660 indicates that the order was completed successfully on 5 Jun. 2009 and accordingly, assumes that the customer is unlikely to contact the contact center with regard to this first contact and no likely resources are identified in the resource set 200.

However, it will be appreciated that the contact manager 32 could determine that despite the fact that the order was completed successfully, the customer may wish to return the order and accordingly, the contact manager 32 may indicate that a returns and/or refund system be identified as a potentially relevant resource to the customer for that order. Furthermore, such a determination may also be dependent on an amount of time that has lapsed since the completion of the order, or, for example, a warranty associated with the order.

For the second contact in the customer transaction history, the contact manager 32 determines that in view of the dispatch problem associated with the order placed, an ordering system, warehouse system and the agent 1008, who was involved in the order, are all potentially relevant resources.

Similarly, for the third contact, in view of problems associated with payment details, the contact manager 32 identifies an ordering system, payment system, agent 0803 and a credit supervisor as potentially relevant resources.

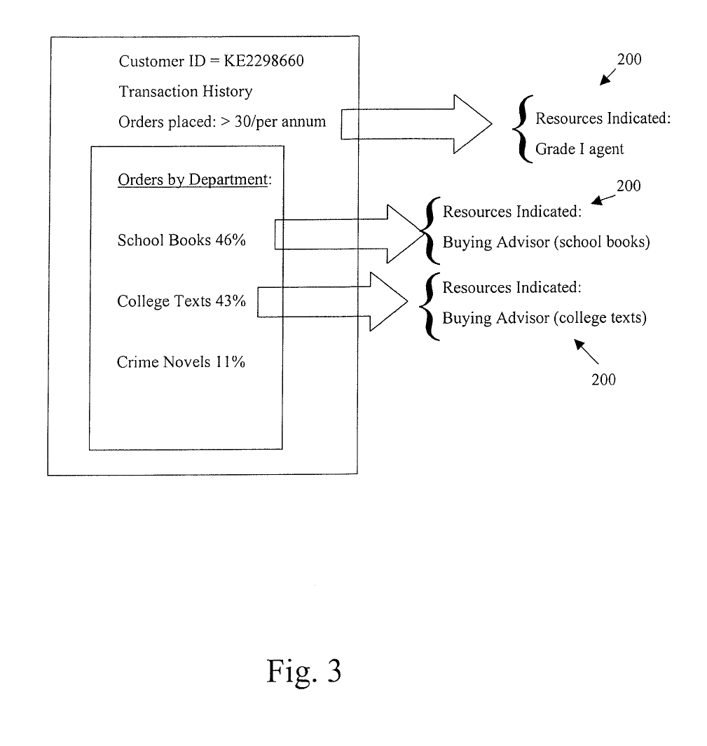

Although the transaction history of a customer may be displayed as a list of previous contacts, each comprising specific details, the transaction history of the customer may be alternatively, or in addition, aggregated to detail an overview of the behavior of a customer, as discussed with reference to FIG. 3.

FIG. 3 illustrates a transaction history of a customer of a book store, and details orders placed by the customer by department. In this case, 46% of the customer's orders were for school books, 43% were for college texts, and 11% were for crime novels.

Given the high percentage of customer orders relating to school and college books, the contact manager 32 identifies both the buying advisor for school books, and the buying advisor for college texts as potentially relevant resources for the customer.

Given that only 11% of the orders placed by the customer related to crime novels, the contact manger determines that there is a much lower likelihood that the customer contacting the contact center will wish to contact a buying advisor for crime novels. Furthermore, given that the customer's transaction history indicates that the customer has never placed an order for a romance novel, again, the contact manger accordingly, will not indicate a buying advisor for romance novels as a potentially relevant resource.

Accordingly, it be appreciated that a threshold value is associated with the determination of whether or not the contact manger indicates a given resource for a particular contact. The threshold value may be dependent on any combination of a plurality of parameters, such as previous purchases, and in particularly, most recently purchased items, time of year, etc.

For example, at the beginning of the school or college year, it is more likely that a customer will purchase school books or college texts than during a non-school or college term. Thus, for example, in July, the likelihood of the customer wishing to avail of resources relating to a buying advisor for crime novels may be much greater than that of a buying advisor for college texts, despite the fact that the customer has purchased a greater number of college texts. Similarly, where a transaction history of a customer indicates that the customer tends to purchase romance novels only in the holiday season, despite the low quantity purchased, the likelihood of the customer requiring the services of a buying advisor for romance novels may increase in December.

The transaction history of customer ID KE2298660 further indicates that the customer is a highly valued customer, and has an associated high priority, as they tend to place a number of orders per annum that exceeds threshold value, and accordingly, the contact manager 32 indicates that a Grade I agent should be reserved for the customer.

Furthermore, the priority level associated with the customer may be utilized to determine whether or not the customer is more entitled to a given resource than an another customer who may also require the services of the resource, as will be explained in more detail below.

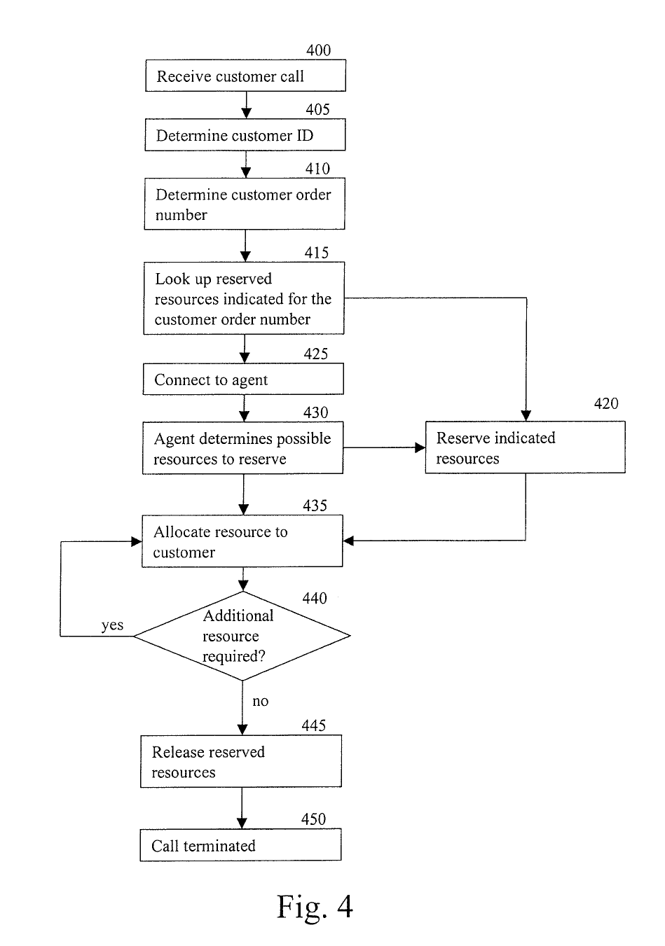

Referring now to FIG. 4, there is a flow diagram depicting a method of managing a contact received at a contact center.

A customer calls a contact center 400 and a IVR session is initiated in the manner described above. During the IVR session, the customer's ID is determined 405. In the case that the customer is contacting the contact center with regard to a previously placed order, a customer order number is alternatively or additionally determined 410.

This information is then utilized to access 415 the customer's transaction history, and to determine any resources identified in the resource set 200 associated with the customer as being potentially relevant.

In the case that a customer order number is gleaned from the customer during the IVR session, the resources identified as being potentially relevant to the customer for that order or contact are reserved 420.

In the case that no customer order number is gleaned from the customer during the IVR session, the resources identified as being potentially relevant to the customer for any orders, or any orders placed within a given time frame, are reserved 420.

However, it will be appreciated that the contact manager 32 will periodically update the relevance or otherwise of the resource set associated with each order. For example, where an order was not completed due to non-payment, it may be initially the case that the ordering system, payment system, agent 0803 and a credit supervisor are all listed as potentially relevant resources, but after a certain amount of time lapses, it becomes less likely that the customer will revisit the order and accordingly, the contact manager will update the resources, if any, that are potentially relevant to the order.

The customer is then connected 425 to an agent. If the agent determines 430 that a resource, other than any already identified in the resource set, should be reserved for the contact, the agent reserves the resource 420. Such a determination maybe based on a number of considerations, such as, a customer request, information provided to the agent by the client from which the agent infers a certain resource may be required, or historical data associated with the customer, such as the transaction history, and from which the agent infers a certain resource may be required.

Accordingly, a set of resources 200 determined by the contact manager 32 may be supplemented, or indeed, created by an agent.

The agent then allocates 435 a resource from the set of resources 200 to the customer.

The resource the agent allocates to the contact may be determined as that deemed most appropriate by the agent.

Alternatively, it may be the resource deemed most appropriate by the customer, and/or deemed most appropriate by the contact manager 32.

In the case that the agent is satisfied that the customer can be dealt with successfully by the allocated resource, 440, and requires no other resources, all other reserved resources from the set of resources are released 445 and made available to other agents. Otherwise the set of resources remain reserved and are allocated to the contact as necessary. When no more resources are to be allocated to the contact, the set of resources are released, 445 and the call terminated, 450.

It will be appreciated however, that once a customer has utilized a given resource, and will not require the resource again for that contact, the resource may be released despite the fact that other resources of the set of resources may yet be allocated to the customer. In this way, once a resource has served the customer, it is released and made available for other customers as soon as possible.

Accordingly, if a contact is allocated to a resource, for example, a credit supervisor, and the credit supervisor determines that they are going to be able to resolve the customer's issue, the credit controller may indicate to the agent and/or contact manager 32, that all other reserved resources associated with the contact should be released.

In the case that two different agents are attempting to reserve the same resource for two different customers concurrently, the customer having a higher priority will be awarded the reservation. In such a situation, a queue may be maintained such that the resource is assigned to the reserved resources of the less prioritized customer(s) once the resource has been released by the agent acting for the high priority customer.

Furthermore, it will be appreciated that the resource queue may be ordered in any manner, for example, in accordance with the priority associated with the customer, and/or a time lapse since a request for the resource was made. Thus, an agent requesting a currently allocated resource may usurp a position of a less prioritized customer in the queue, or alternatively, may even usurp the resource from the customer it is currently allocated to.

The invention is not limited to the embodiment(s) described herein but can be amended or modified without departing from the scope of the present invention.

1. A computer-implemented method of reserving resources for a customer contacting a contact center, the method including the steps of:
a) identifying said customer associated with a contact received at said contact center;
b) accessing a customer profile to determine at least one non-agent resource to be associated with said contact based on said customer profile;
c) reserving said non-agent resource for said contact; and
d) allocating said non-agent resource to said contact.

2. The computer-implemented method of claim 1, wherein said customer profile comprises a record of at least one prior contact between said customer and a contact center.

3. The computer-implemented method of claim 1, wherein said customer profile comprises information gleaned from at least one of a social networking site, an online public forum, and a market research organisation.

4. The computer-implemented method of claim 1, wherein said identifying said customer comprises determining an order number, an open issue tracking number, or an identifier that associates the customer with a commercial or other transaction with the business, associated with said at least one prior contact.

5. The computer-implemented method of claim 1, wherein said identifying said customer comprises identifying a communications address from which said contact is received, the communications address being selected from a telephone number, an IP address, an email address, a SIP address, an IM address, and a uniform resource indicator.

6. The computer-implemented method of claim 1, wherein said identifying said customer comprises gleaning a customer identifier during an IVR session.

7. The computer-implemented method of claim 1, wherein after the step of reserving said non-agent resource and before the step of allocating said non-agent resource to said contact, said non-agent resource is made unavailable for reservation by or allocation to other contacts of said contact center.

8. The computer-implemented method of claim 1, further comprising the step of releasing said non-agent resource after allocating said non-agent resource to said contact, such that after releasing said non-agent resource it is made available for reservation by or allocation to other contacts of said contact center.

9. The computer-implemented method of claim 8, wherein said step of releasing said non-agent resource is carried out by a management system of said contact center in response to an instruction received from said customer.

10. The computer-implemented method of claim 8, wherein said step of releasing said non-agent resource is carried out by a management system of said contact center in response to a termination of said contact.

11. The computer-implemented method of claim 1, further comprising the step of assigning a human agent of said contact center to said contact to engage with said contact, whereby said agent is engaged with said contact during a first period of time which overlaps with a second period of time defined between said steps of reserving said non-agent resource and allocating said non-agent resource.

12. The computer-implemented method of claim 11, wherein said step of allocating the resource to the contact comprises disengaging said human agent from said contact, such that the first and second periods of time end substantially simultaneously.

13. The computer-implemented method of claim 1, further comprising the step of assigning a human agent of said contact center to said contact to engage with said contact, and wherein allocating said non-agent resource to said contact comprises maintaining a conference call between at least said customer, said non-agent resource and said human agent.

14. The computer-implemented method of claim 11, wherein, responsive to said human agent determining at least one additional non-agent resource to be associated with said contact, reserving said additional non-agent resource.

15. The computer-implemented method of claim 14, wherein determining additional non-agent resources for association with said contact is based on a customer request, information gleaned from said customer, and/or a recommendation by said agent.

16. The computer-implemented method of claim 1, wherein said step of reserving said at least one non-agent resource comprises determining that said non-agent resource is allocated to or reserved for a second contact associated with a second customer, and adding a reserve request for said contact to a reserve queue associated with the non-agent resource.

17. The computer-implemented method of claim 1, wherein said step of reserving said at least one non-agent resource comprises determining that said non-agent resource is allocated to or reserved for a second contact associated with a second customer, determining that said second customer has a lower priority level than the customer, and usurping the non-agent resource from the second contact.

18. The computer-implemented method of claim 1, wherein said step of reserving said at least one non-agent resource comprises determining that said non-agent resource is reserved for a second contact associated with a second customer, usurping the non-agent resource from the second contact.

19. The computer-implemented method of claim 1, wherein said step of reserving said at least one non-agent resource comprises determining that said non-agent resource is allocated for a second contact associated with a second customer, adding a reserve request for said contact to a reserve queue associated with the non-agent resource.

20. A computer-implemented method of reserving resources for a customer contacting a contact center, the method including the steps of:
a) identifying the customer associated with a contact received at the contact center;
b) accessing a resource set of preemptively identified potentially relevant non-agent resources that may be required by the customer;
c) reserving the non-agent resource for the contact; and
d) allocating the resource to the contact.

21. A computer-implemented method of reserving resources for a customer contacting a contact center, the method including the steps of:
a) accessing a customer profile;
b) identifying a resource set of potentially relevant non-agent resources that may be required by the customer, based on said customer profile; and
c) responsive to receipt of a subsequent customer contact, reserving at least one of the resources of the resource set for the customer contact.

22. A contact centre system comprising:
a) a network connection for receiving a contact from a customer;
b) a contact manager for identifying said customer associated with a contact received at said network connection;
c) a storage area containing a customer profile from which it is possible to determine at least one non-agent resource to be associated with said contact based on said customer profile;
d) a resource reservation system operable to reserve said non-agent resource for said contact; and
e) a resource allocation system for allocating said non-agent resource to said contact.

23. A contact centre system comprising:
a) a network connection for receiving a contact from a customer;
b) a contact manager for identifying said customer associated with a contact received at said network connection;
c) a storage area containing a resource set of preemptively identified potentially relevant non-agent resources that may be required by the customer;
d) a resource reservation system operable to reserve said non-agent resource for said contact; and
e) a resource allocation system for allocating said non-agent resource to said contact.

24. A contact centre system comprising:
a) a storage area containing a customer profile from which it is possible to determine a resource set of potentially relevant non-agent resources that may be required by a customer based on said customer profile;
b) a resource identification system for identifying, in advance of a contact from a customer, a resource set of potentially relevant non-agent resources that may be required by a customer based on said customer profile; and
c) a resource reservation system operable, in response to receipt of a customer contact at the contact centre, to reserve at least one of the resources of the resource set for the customer contact.
